(19) United States
(12) Patent Application Publication
(10) Pub. No.: US 2023/0196766 A1
(43) Pub. Date: Jun. 22, 2023

(54) Artificial Reality Applications Through Virtual Object Definitions and Invocation

(71) Applicant: Meta Platforms Technologies, LLC, Menlo Park, CA (US)

(72) Inventors: Pol PLA I CONESA, San Francisco, CA (US); Michal HLAVAC, Seattle, WA (US); Wai Leong CHAK, London (GB); Yeliz KARADAYI, Seattle, WA (US)

(21) Appl. No.: 17/559,461

(22) Filed: Dec. 22, 2021

(51) Int. Cl. G06V 20/20; G06V 20/70; G06V 10/70; G06V 10/77

(52) U.S. Cl. CPC G06V 20/20; G06V 20/70; G06V 10/768; G06V 10/7715

(57) ABSTRACT

Aspects of the present disclosure are directed to a virtual object system for displaying invoked virtual objects in an artificial reality environment. An application can be defined as a collection of virtual objects, each having a definition that defines how and when each virtual object is displayed. For example, an invocation context can be defined for a virtual object, and the virtual object can be invoked when the invocation context is met. A virtual object manager can be provided to the artificial reality (“XR”) device that displays the virtual objects in the artificial reality environment. The virtual object manager can be capable of: selectively and dynamically retrieving virtual objects that are part of the application for on-device storage; and determining which of the application's virtual objects to display given current conditions (e.g., context for a user of the XR device and the device itself, currently displayed virtual objects, etc.)

### TECHNICAL FIELD

The present disclosure is directed to defining, invoking, and displaying virtual objects in an artificial reality system.

### BACKGROUND

Interactions with computing systems are often founded on a set of core concepts that define how users can interact with that computing system. For example, early operating systems provided textual interfaces to interact with a file directory. This was later built upon with the addition of “windowing” systems, whereby levels in the file directory and executing applications were displayed in multiple windows, each allocated a portion of a 2D display that was populated with content selected for that window (e.g., all the files from the same level in the directory, a graphical user interface generated by an application, menus or controls for the operating system, etc.). As computing form factors decreased in size and added integrated hardware capabilities (e.g., cameras, GPS, wireless antennas, etc.) the core concepts again evolved, moving to an “app” focus where each app encapsulated a capability of the computing system. New artificial reality systems have provided opportunities for further object and interaction models.

Existing artificial reality systems provide virtual objects, such as 3D virtual objects and 2D panels, with which a user can interact in 3D space. Existing artificial reality systems have generally backed these virtual objects by extending the app core computing concept. For example, a user can instantiate these models by activating an app and telling the app to create the model, and using the model as an interface back to the app. Such existing artificial reality systems are unintuitive, inflexible, and difficult to create content for. For example, existing artificial reality systems typically limit virtual objects to be used by the app that created them, require each user to learn how to use the virtual objects crated by each app, and make virtual object development labor intensive and prone to error.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIGS. 5A and 5B are conceptual diagrams illustrating a breakdown of virtual object components.

FIG. 6 is a conceptual diagram illustrating a virtual object in 3D space displayed according to a view state from a template.

FIG. 7 is a conceptual diagram illustrating components of a virtual object definition.

FIG. 8 is a block diagram illustrating a virtual object data structure.

FIGS. 9-14 are diagrams illustrating example implementations of virtual object invocation and display.

FIG. 15 is a flow diagram for defining a virtual object.

FIGS. 16 and 17 are flow diagrams for invoking and displaying virtual objects in an artificial reality system in some implementations.

FIG. 18 is a diagram of a system for invoking and displaying virtual objects in an artificial reality system.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a virtual object system for displaying invoked virtual objects in an artificial reality environment. An application can be defined as a collection of virtual objects, each having a virtual object definition that defines how and when each virtual object is displayed in the artificial reality environment. For example, invocation context can be defined for a virtual object, and the virtual object can be invoked when the invocation context is met. The virtual object definition can also include application logic, which, when executed, generates content data to be displayed by or with the virtual objects. For example, running the application logic can include retrieving data from one or more data sources (e.g., social graph, user preferences, third-party APIs or data structures, and the like), processing this data, and generating content for the virtual object based on the results of the processing. The virtual object definition can also include location data that identifies where in the artificial reality environment the virtual object should be initially displayed.

The artificial reality environment can be implemented by an artificial reality (“XR”) device associated with (e.g., worn by) a user. The user can then experience the real-world with virtual overlays provided through the interface of the XR device. The user's experience can include contextual factors, such as the device location, time of day, day of week, user preferences, user's transaction or purchase history, weather conditions, density of surrounding people, indoor or outdoor setting, and many others. In some implementations, the contextual factors can include user context, device context, and environmental context.

The invocation context of a virtual object can be defined as one or more contextual data attributes and the data values of these attributes. For example, a virtual object may include the following invocation context: indoor, proximate to a predefined location (e.g., restaurant location), during non-night hours, on a weekend. When a user and device's contextual factors (e.g., contextual attributes and data values) meet these conditions, the virtual object is invoked.

In some implementations, the comparing the contextual factors to the invocation context can be performed in a cloud environment and/or at the XR device. In an example, the XR device can transmit contextual factors to the cloud environment, and the contextual factors can be compared to invocation context of one or more virtual objects. In another example, the XR device may receive multiple virtual objects from the cloud environment, and contextual factors can be compared to invocation contexts of the multiple virtual objects.

In some implementations, an application can include a set of virtual objects. For example, a particular entity location (e.g., restaurant location) can include several virtual objects for display at various locations in or proximate to the entity location. When invocation context of a virtual object that is part of an application are met, the application can be transmitted from the cloud environment to the XR device.

For example, receiving the application at the XR device can include receiving the following data items for each virtual object in the set: invocation context, application logic, and display location data. Invoking a virtual object can include running the virtual object's defined application logic to retrieve data relevant to the virtual object, analyzing or processing the data, and generating content for the virtual object's display. For example, the application logic can include code to: retrieve menu items from a data source associated with a restaurant location, retrieve user preference from a user's social graph, retrieve medical information for a data source related to the user, and the like. This data can then be analyzed to arrive at content data for the virtual object. In the above example, code can be defined that analyzes user preferences and allergies to highlight one or more menu items from a restaurant's food menu. Any other suitable application logic can be implemented.

The virtual object definition can also include location data that defines how the virtual object is to be initially displayed in the artificial reality environment. For example, the location data can define that the virtual object should be initially displayed proximate to a menu in a particular restaurant. In this example, because the invocation context parameters of the virtual object are related to a restaurant location, the restaurant's menu is expected to be near or proximate the user and XR device. The XR device can be configured to display the virtual object according to the virtual object's data (e.g., display the virtual reality object content at the defined location).

In operation, the XR device can transmit contextual factors to the cloud environment, and the contextual factors can be compared to invocation contexts of multiple virtual objects. For example, the cloud environment can store multiple (e.g., a large number) of virtual object definitions, and the contextual factors from the XR device may be relevant to a subset of these multiple virtual objects. The contextual factors can be compared to invocation contexts of the subset of virtual objects to determine whether any of the virtual objects' invocation contexts are met.

At times, invocation contexts for many of the subset of virtual objects may be met. In an example, the virtual objects with met invocation contexts can be ranked, for example according to relevancy to the XR device and/or user, or according to any other suitable ranking. One or more of the highest ranked virtual objects can then be selected for transmission to the XR device. When a virtual object that is part of an application is selected, components of the application can be transmitted to the XR device at once, or portions may be transmitted over time. The XR device may be configured to display virtual objects with met invocation contexts to the user in an artificial reality environment.

In some implementations, an application that includes a set of virtual objects also includes a virtual object manager that is received at the XR device (e.g., as a component of the application). The virtual object manager can compare contextual factors to invocation contexts of the set of virtual objects on the XR device and cause one or more of the set of virtual objects to be displayed when invoked. In some cases, when the application is provided to the XR device, it includes the virtual object manager and one or more of the virtual objects of that application, but not other of the virtual objects of that application. The virtual object manager can determine when invocation contexts are met, are likely to be to be met in the near future, or are partially met and can obtain corresponding virtual objects from the cloud systems. In some implementations, invocation contexts for multiple of the set of virtual objects can be met by the contextual factors. In this example, the virtual object manager can rank the multiple virtual objects with met invocation contexts and select a subset for display. For example, application logic for the subset of the virtual objects can be run such that content data for the subset is generated, and the subset of virtual objects can be displayed in the XR device.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

In existing artificial reality systems, virtual objects are typically part of large applications that are cumbersome to develop and implement. For instance, these applications often function as a single monolithic entity, and because of this, the full application is downloaded before it can be run. As a result, invoking a virtual object in a conventional system can often require download and storage of a large application. The full application can take a significant amount of time to download and install, which negatively impacts the timeliness and relevance of any virtual objects invoked. Further, these full applications unnecessarily occupy storage space on an XR device.

The virtual object system and methods described herein are expected to overcome these failing in existing artificial reality systems, providing an architecture that is more intuitive, lightweight, scalable, and dynamic. Applications can be broken down into a collection of lightweight virtual objects and a virtual object manager that enable timely and efficient virtual object invocation and display. For example, an application's virtual object manager can be provided to an XR device, and the virtual objects of the application can be retrieved (by the virtual object manager) as needed. In some implementations, the virtual object manager pre-caches (e.g., downloads in advance of invocation) virtual objects on the XR device based on future relevancy. This lightweight architecture enables timely invocation and display of virtual objects while using fewer computing resources.

For example, virtual objects can be invoked and displayed even though the entire application is not stored on the XR device, which significantly speeds up the time between determined virtual object relevancy and virtual object display. In addition, portions of the application can be stored on the XR device rather than the full application, which frees up the limited storage on the XR device for additional uses. Further, the functionality to pre-cache virtual objects that may become relevant in the near future provides even faster display of relevant virtual objects. The lightweight architecture also provides significant benefits to developers, as creating applications involves the simple process of generating a collection of virtual objects (with the logic and content—which may be reused from other objects) and defining an invocation context and location for each virtual object.

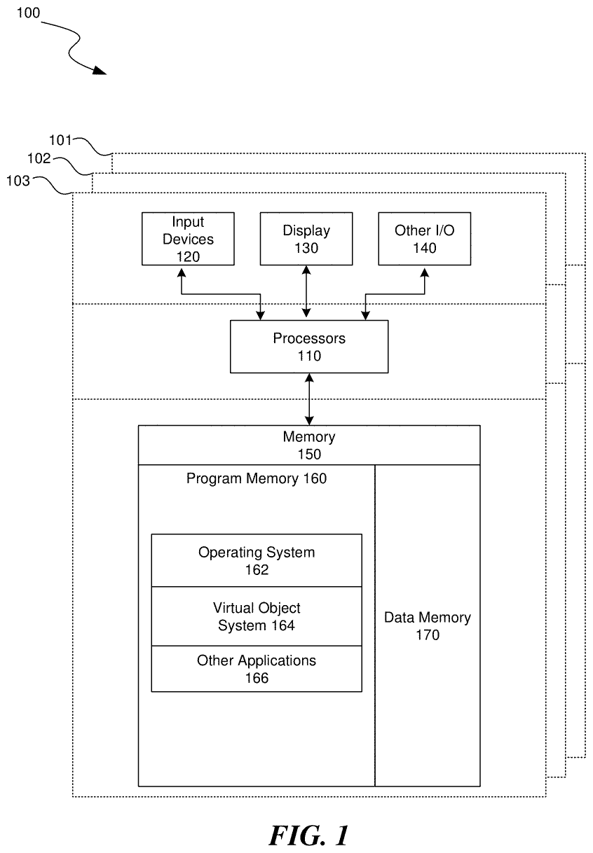

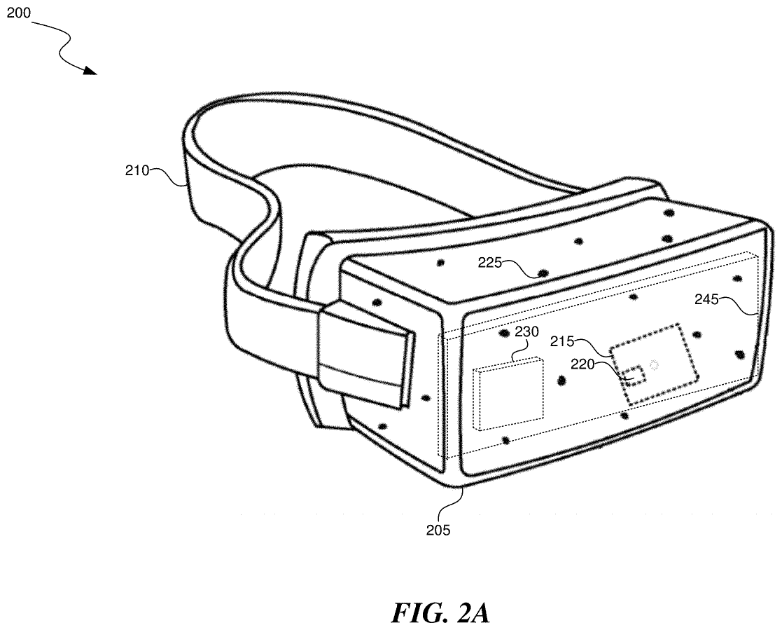

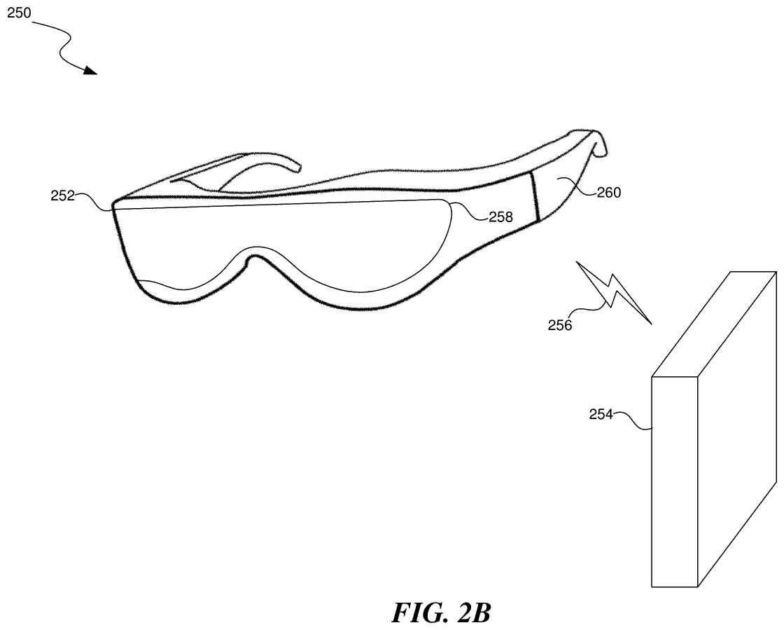

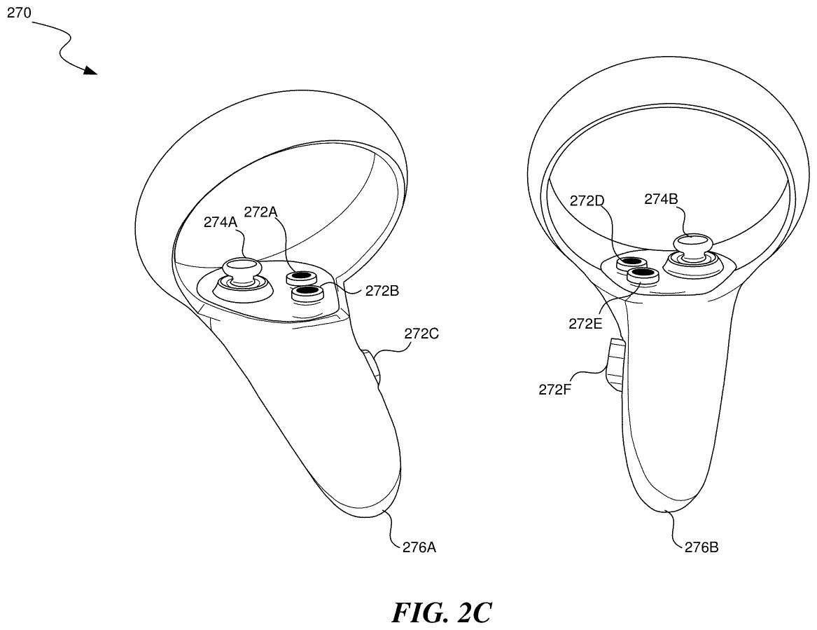

Several implementations are discussed below in more detail in reference to the figures. FIG. 1 is a block diagram illustrating an overview of devices on which some implementations of the disclosed technology can operate. The devices can comprise hardware components of a computing system 100 that facilitates the invocation of virtual objects and the displayed of invoked virtual objects at an artificial reality device. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, virtual object system 164, and other application programs 166. Memory 150 can also include data memory 170 that can include virtual objects definitions, application definitions, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270, which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

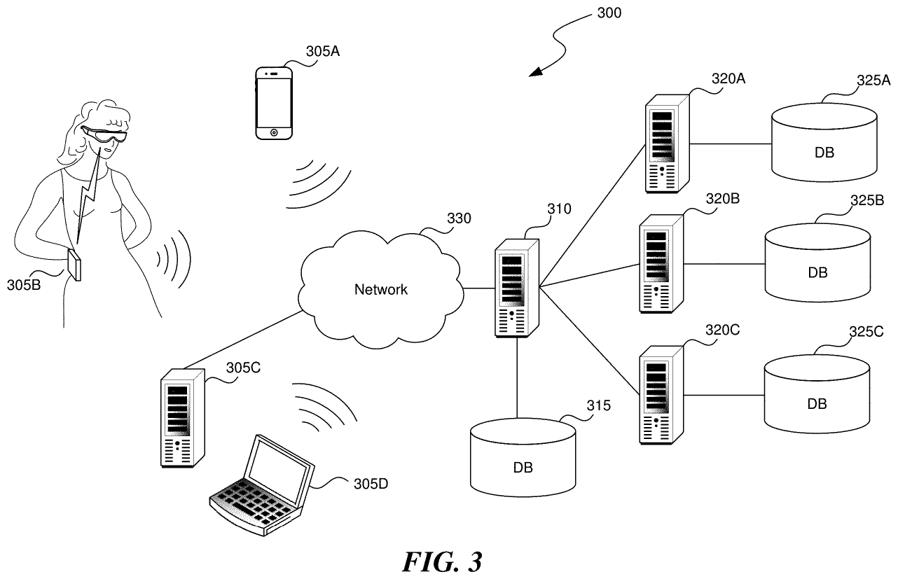

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

In some implementations, servers 310 and 320 can be used as part of a social network. The social network can maintain a social graph and perform various actions based on the social graph, A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes hi the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile, It can enable a user to post a message to a group or a fan page. It can enable a user to comment on an image, wall post or other content item created or uploaded by the user or another user. And it can allow users to interact (via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. hi some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

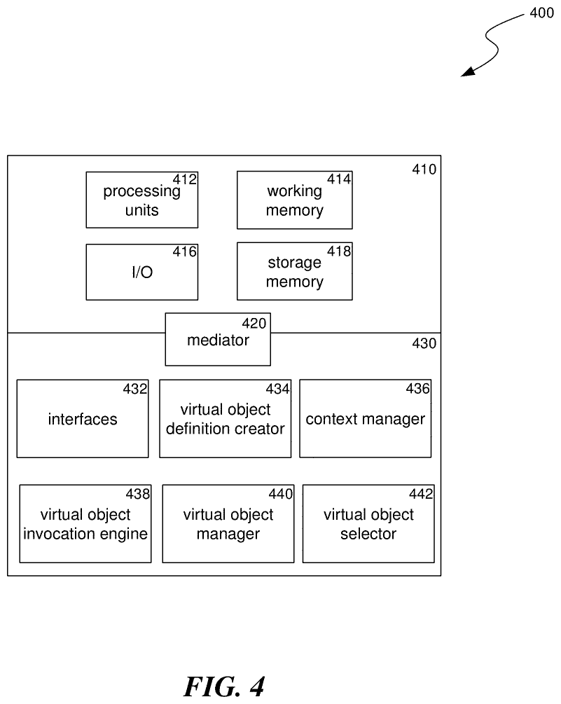

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for the creation, invocation, and display of virtual objects, defined as a collection of components. Specialized components 430 can include virtual object definition creator 434, context manager 436, virtual object invocation engine 438, virtual object manager 440, virtual object selector 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

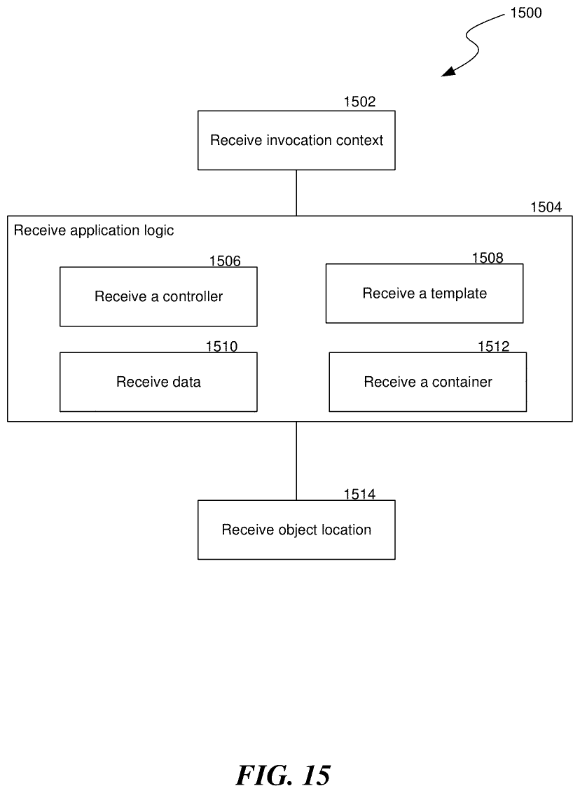

Virtual object definition creator 434 can create definitions of new virtual objects by receiving foundational data about the new virtual object (e.g., a designation of which object in an object hierarchy the new virtual object extends), defining components (e.g., container, data, controller, and/or template) or component portions of the new virtual object. Additional details on defining a virtual object are provided below in relation to FIG. 15.

In some implementations, a template can be defined for virtual objects that can be used by virtual object definition creator 434 or stored in a library of prefabricated templates (usable by other systems) to create virtual objects. Each template can specify a state machine with one or more view states (each defining which and how data elements of a virtual object are displayed while that view state is active for the virtual object) and contextual breakpoints for transitioning between which view state is the active view state.

In some implementations, a hierarchy of virtual object definitions can be defined, where each virtual object definition can inherit components from its parent in the hierarchy. A base object definition can specify default features of virtual objects, allowing for virtual objects to be quickly created by developers and have consistent and expected behaviors for users. In some implementations, the hierarchy can specify a set of native object definitions that extend the base object, for common types of virtual objects, such as people, places, events, social media posts, conversations, groups, photos, webpages, etc. In some implementations, a special purpose object definition that extends the base object can define a virtual object for content items which may be commonly used, imported from other platforms, and/or that are user defined. In yet further implementations, a custom virtual object definition that extends the base object can allow developers to create virtual object definitions that inherit some basic content and/or functionality from the base object, allowing them to be used in an artificial reality environment, while providing full flexibility to the developer to define and customize other aspects of the objects.

Context manager 436 can manage contextual factors for an XR device and/or a user of the device. For example, a user associated with (e.g., wearing) the XR device can interact with the real-world or an artificial reality, and the contextual factors managed by context manager 436 during these interactions can include: the user's/device's location in the real-world, the time (e.g., time of day, day of week/month), aspects from the user's node and/or connections on a social graph, user or device preferences, user transactions or purchase history, and other suitable context. Context manager 436 can access, receive, or retrieve the contextual factors from different sources (e.g., the XR device, a server, a data store, and any other suitable computing device).

Virtual object invocation engine 438 can compare the contextual factors managed by context manager 436 to invocation contexts specified in virtual object definitions and cause virtual objects to be invoked based on the comparisons. For example, the invocation context defined for a virtual object can be a set of conditions combined by operators (e.g., an expression containing data attributes and data values). An invocation context can be met when the contextual factors for an XR device and/or user (e.g., current contextual factors) meet the combined conditions, such as when the expression evaluates to True. When an invocation context is met, virtual object invocation engine 438 can cause an instantiation of the corresponding virtual object.

Virtual object manager 440 can manage the invocation and/or distribution of multiple virtual objects. In some implementations, a set of virtual objects can be part of an application, and virtual object manager 440 can be an application manager. For example, an application can include several virtual objects configured for display in a common location (e.g., restaurant location, other retail location, etc.). Once a virtual object that is part of an application is invoked, virtual object manager 440 can obtain the virtual objects invoked if not already resident on the XR device and can manage the invocation of the invoked virtual objects—e.g., using the virtual object's definitions to place them in an artificial reality environment and causing them to execute their logic to configure themselves for how and where that virtual object is initially displayed.

In some implementations, a large number of virtual object definitions can be stored such that determining which of the large number of virtual objects are invoked at any given time may present computational challenges. Virtual object manager 440 can manage the large number of virtual objects so that virtual object invocation engine 438 selectively compares current contextual factors to invocation contexts for only a subset of the large number of virtual objects. For example, current contextual factors for an XR device/user may be relevant to a portion of the stored virtual objects, and virtual object manager 440 can manage the large number of virtual objects and present only a subset of relevant virtual objects to virtual object invocation engine 438.

Virtual object selector 442 can be used to select one or more virtual objects for invocation when the invocation contexts of multiple virtual objects are met by current contextual factors. For example, virtual object invocation engine 438 compares contextual factors to virtual objects definitions to determine which objects have met invocation contexts. In some implementations, multiple virtual objects will have met invocation contexts, and virtual object selector 442 can select one or more of the multiple virtual objects for invocation. The virtual objects with met invocation contexts can be ranked (e.g., according to relevance to the current contextual factors for a XR device and user). The one or more virtual objects selected for invocation can be those highest in the ranking, or any other suitable selection criteria can be implemented. Once selected, the virtual objects can be invoked/instantiated and displayed at the XR device.

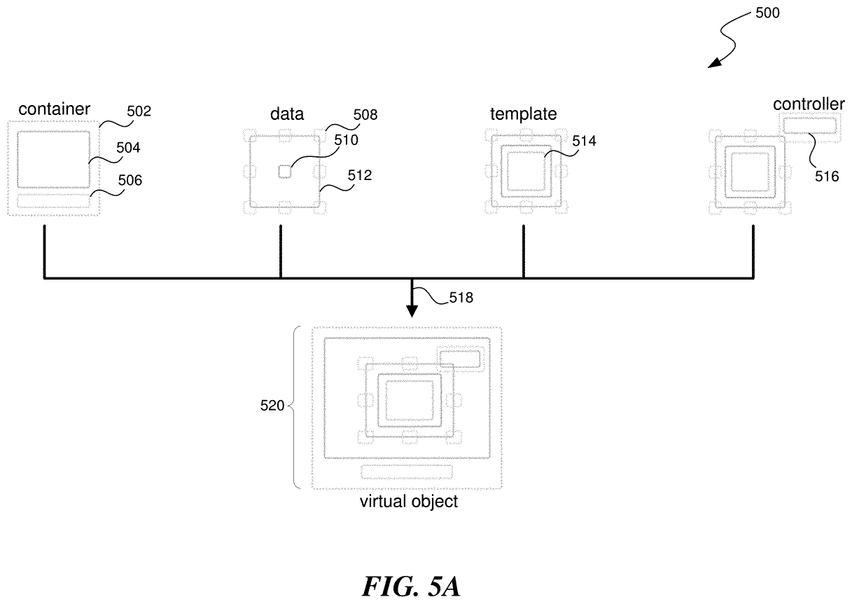

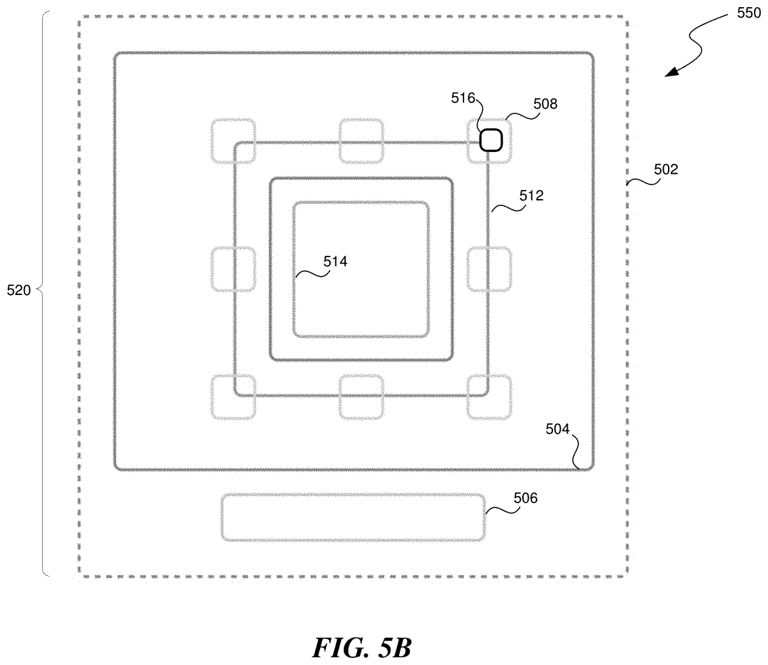

FIGS. 5A and 5B are conceptual diagrams 500 and 550 illustrating a breakdown of an object into components including a container, data, a template, and a controller. The container defines a volume, allocated to the virtual object by an application controlling an artificial reality environment, into which the virtual object can write to provide output. In conceptual diagram 500, the container includes an outer container 502 for the overall virtual object, a first inner container 504 for visual elements of the virtual object, and a second inner container 506 for UI elements of the virtual object. Examples of the data include the displayable (e.g., visual, auditory, haptic, etc.) elements that can be output by the virtual object; state or properties of the virtual object (e.g., configuration, settings, etc.); and meta data of the virtual object (e.g., identifiers, location, name, semantic identifiers, etc.)

In conceptual diagram 500, the data includes external, dynamic data, such as data 508, that the virtual object accesses, internal data 510 that is local to the virtual object, and relationships among data elements 512. The template 514 includes multiple view states, where each view state defines how the virtual object presents itself when that view state is active. A view state can, e.g., set a configuration of the container, map which data elements of the virtual object are displayed and where they are displayed within the container, which UI elements are shown/hidden, or define other output for the virtual object. The template can act as a state machine where each view state is a state in the state machine and there is contextual breakpoint logic that defines when the virtual object transitions between the view states. A controller 516 can include logic specifying how the virtual object responds to user actions, determined world state/context, input from system services and applications (e.g., communication from network), etc. The portion 516 of the controller illustrated in conceptual diagram 500 illustrates logic of the controller controlling how data element 508 plugs into an external source (e.g., if the virtual object 520 is a person object, controller 516 can define how the person ID 508 is connected to an element in a social graph—linking the person virtual object 520 to other people in the social graph defined as “friends” of the person represented by the virtual object 520).

The components of the virtual object can be combined, as shown by line 518, to create the overall virtual object 520, which is shown in larger view in FIG. 5B. Thus, FIG. 5B illustrates the conceptual design of a virtual object, including a container 502 (with sub-containers 504 and 506) defining a volume for the virtual object data elements, such as data element 508, which are laid out according to an active view state of a template 514, and where actions of the virtual object and connections of the virtual object to external sources are controlled by controller, such as controller portion 516.

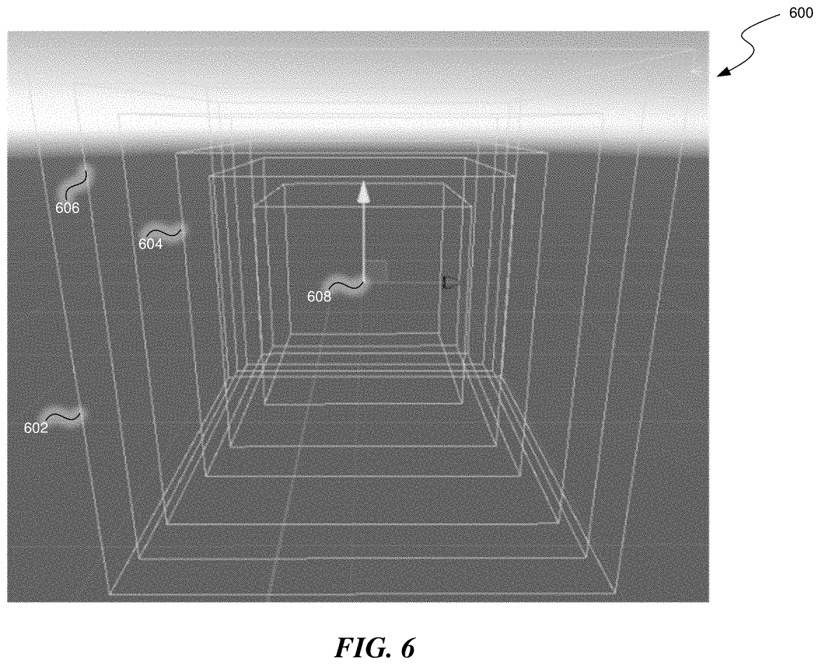

FIG. 6 is a conceptual diagram 600 illustrating an object in 3D space displayed according to a view state from a template. Other conceptual diagrams illustrated herein use 2D representations of virtual objects and virtual object components for clarity. Conceptual diagram 600 illustrates a 3D artificial reality environment to show that these virtual objects can be made up of 3D elements that exist in the 3D artificial reality environment. In conceptual diagram 600, a virtual object has an outer container 602 defining the overall volume into which the virtual object can write to display its elements. Conceptual diagram 600 also shows bounding boxes 604 and 606 as two possible areas, within the volume 602, that each could be defined by a view state for displaying some of the virtual object's data elements while in that view state. Conceptual diagram 600 further shows an origin point 608, which the view states can use as a point to define positions of data elements within the virtual object.

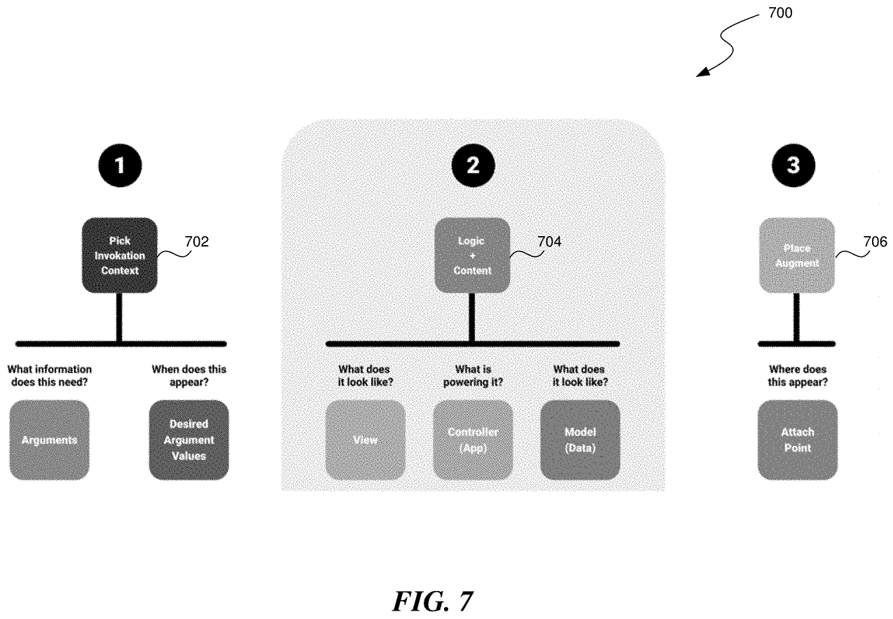

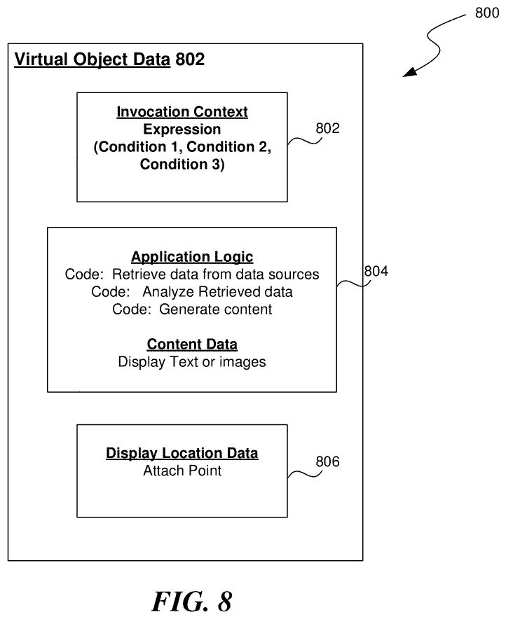

In operation, the invocation and display of virtual objects is based on the components of the virtual object definitions. FIG. 7 is a conceptual diagram illustrating components of a virtual object definition and FIG. 8 is a block diagram illustrating a virtual object data structure. Diagram 700 includes conceptual invocation context 702, conceptual application logic 704, and conceptual display location 706. The virtual object data structure 800 includes invocation context data 802, application logic data 804, and display logic data 806.

The determination as to when a virtual object should be displayed is controlled by conceptual invocation context 702. As depicted in invocation context data 802, the invocation context can include an expression that combines several conditions (e.g., using logical operators). The expression contains data arguments (e.g., elements of data, such as time of day, day of week, location, and the like) and the argument values (e.g., data values) that the arguments should hold to invoke the virtual object.

For example, a virtual object may include the following invocation context: outdoor, proximate to a predefined location (e.g., retail establishment), during lunch hours, and during the weekdays. An example expression that represents this example invocation context can be: (Indoor_Outdoor==‘outdoor’ AND Current_location<=0.5_miles from Predefined_location AND 11:00 am<=Current_Time_of_Day<=2:00 pm AND Day_of_Week==[Mon, Tues, Wed, Thurs, Fri]). If the data attribute values for an XR device and user (e.g., current contextual factors) are plugged into the example invocation context such that the expression evaluates to “True” or “1”, the virtual object's invocation context is met. In this example, if the expression evaluates to ‘False” or “0”, the virtual object's invocation context is not met.

The content and controller for the virtual object are defined by conceptual application logic 704. As depicted in application logic data 804, the application logic can include code to execute that generates content and determine a look for the virtual object. For example, the virtual object's view and the data or content that is displayed by the virtual object can be based on executed application logic. The application logic can also include the virtual object's controller, which can determine how a user interacts with the object, how an object changes views, and other behaviors of the virtual object in response to interactions, updates to contextual factors, and other suitable updates. The application logic and content of a virtual object defined in this disclosure can include virtual objects' controllers, templates, data, and containers as disclosed in U.S. application Ser. No. 17,511,887, filed Oct. 27, 2021, titled VIRTUAL OBJECT STRUCTURES AND INTERRELATIONSHIPS, which is hereby incorporated by reference in its entirety.

The determination as to where a virtual object should be initially displayed in an artificial reality is controlled by conceptual display location 706. As depicted in display location data 806, the virtual object can be displayed adjacent to (e.g., attached to) a predetermined attached point in an artificial reality environment. For example, an attach point for a virtual object displayed in a retail location, such as a gym, can be a piece of exercise equipment. In this example, the virtual object can include instructions and/or visualizations about how to operate the exercise equipment. In some implementations, the attach point can be a recognized object in the artificial reality.

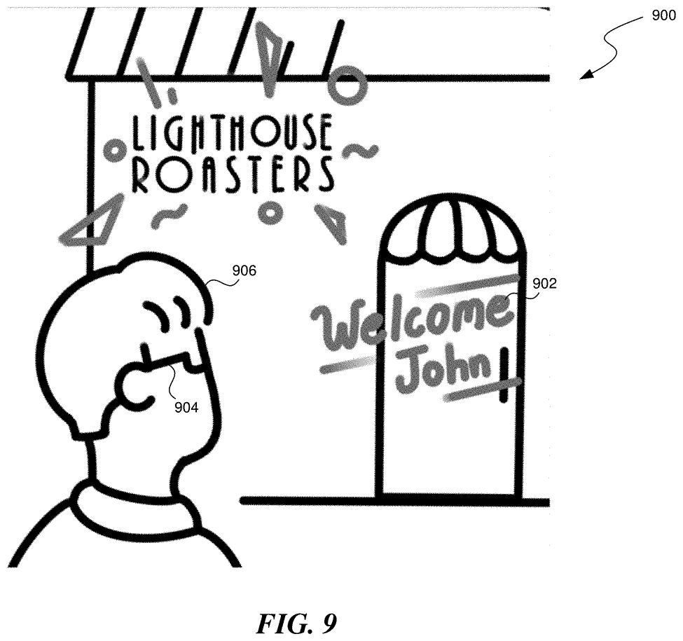

In operation, a set of virtual objects can be defined that together comprise an application. The set of virtual objects can be related based on any suitable commonality, such as a common location (e.g., restaurant location, gym location, and the like), common use (e.g., bathroom indicators), common third-party characteristic (e.g., content from a same third-party), and the like. In some implementations, a developer defines that a collection of virtual objects is part of a same application. FIGS. 9-14 are diagrams illustrating example implementations of virtual object invocation and display for a set of virtual objects that comprise an application. FIGS. 9, 11, and 13 illustrate virtual objects 902, 1102, and 1302 as components of an application defined for a coffee house location.

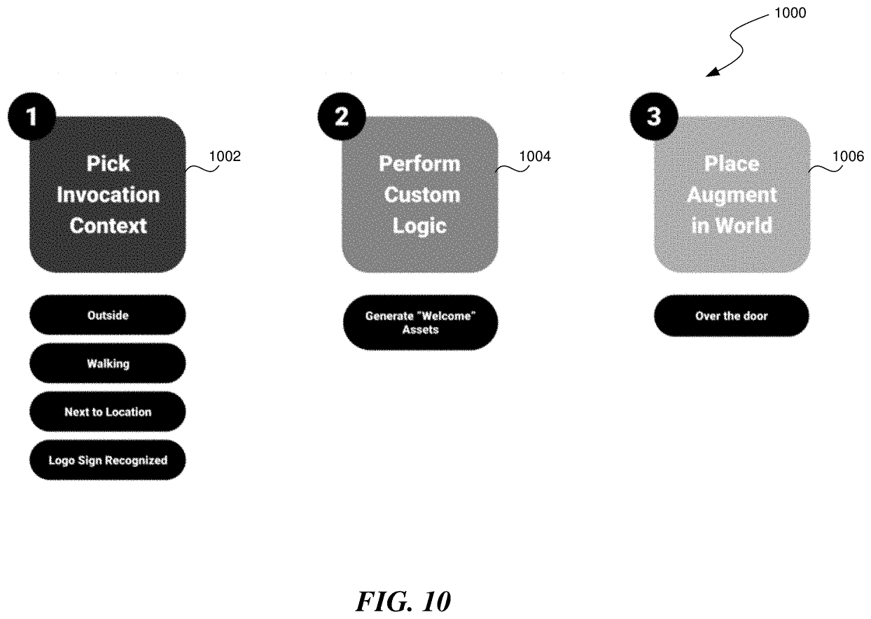

Diagram 900 of FIG. 9 illustrates an artificial reality environment with user 906 and XR device 904. Virtual object 902 can be invoked and displayed to user 906 using XR device 904. Conceptual definition 1000 of FIG. 10 illustrates the definition of virtual object 902. For example, invocation context 1002 of virtual object 902 can include the following data attributes and values: Inside_Outside==“outside” AND Activity_Status==“walking” AND Current_location proximateTo Predefined_location AND LogoSign_Recognized==True. Because invocation context 1002 is met, application logic 1004 can be executed. Application logic 1004 can generate the ‘Welcome” Assets (e.g., content data) for display by virtual object 902, such as retrieving user 906's name from the user's social graph or profile. In addition, location data 1006 defines that virtual object 902 should be displayed over the door of the restaurant location. In some implementations, contextual factors for XR device 904 and user 906 are compared to invocation context 1002 in a cloud environment. Once invocation context 1002 is met, data for virtual object 902 can be transmitted to XR device 904. Virtual object 904 can be instantiated and displayed to user 906 at the defined location (e.g., over the door) in the artificial reality, as illustrated in FIG. 9.

In some implementations, once virtual object 902 is invoked multiple components of the application can be transmitted to XR device 904. This may be a virtual object manager and all, or a subset of, the virtual objects of the application. For example, one or more of virtual object 1102, virtual object 1302, and a virtual object manager can be transmitted to XR device 904. The cloud environment may transmit these components of the application in response to an event or action, such as the user interacting with displayed virtual object 902 or updated contextual factors (e.g., the user entering the coffee house). In other implementations, the various components of the application can be transmitted to XR device 904 at different times.

For example, the virtual object manager can determine that a set of virtual objects of the application have at least part of their invocation context met (e.g., using a current or nearby location or using a current or upcoming time), and in response to this, determining that these invocation contexts are more likely to be met and pre-caching the corresponding virtual objects. In this example, parts of a virtual object can be transmitted to XR device 904, such as the invocation contexts for several (or all) of an application's virtual objects. Because XR device 904 has a set of invocation contexts (full or partial set), the virtual object manager can use the current contextual factors to determine which virtual objects are likely to be relevant, and pre-cache (e.g., retrieve from the cloud environment) full definitions (e.g., application logic, placement information, any other virtual object data) for these relevant virtual objects.

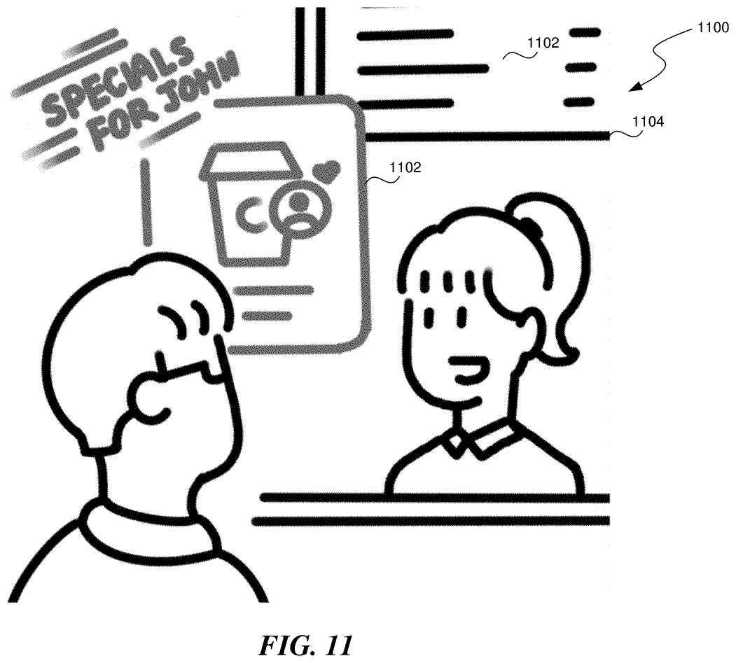

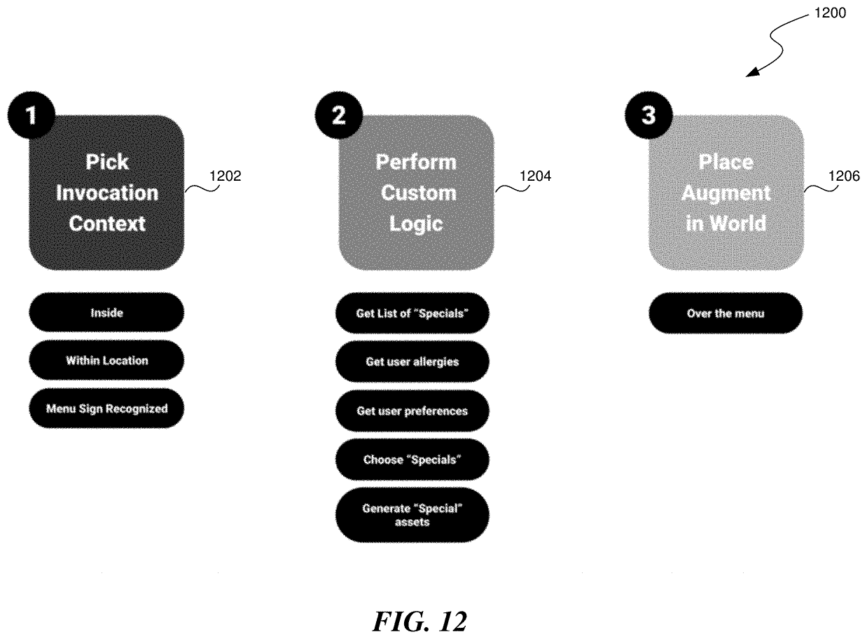

Diagram 1100 of FIG. 11 illustrates an artificial reality environment inside the coffee house (after display of virtual object 902 and after user 906 enters the coffee house). Virtual object 1102 can be displayed adjacent to the coffee house's real-world menu 904. Conceptual definition 1200 of FIG. 12 illustrates the definition of virtual object 1102. For example, invocation context 1202 can include the following data attributes and values: Inside_Outside==“inside” AND Current_location within Predefined_location AND MenuSign_Recognized==True. Because invocation context 1202 is met, application logic 1204 can be executed. Application logic 1204 can, when executed, perform the following functions: retrieve a list of special or other menu items for the coffee house from a data store (e.g., third-party data store); retrieve allergies from user 906's preferences, profile, or health data; retrieve food and drink preferences from user 906's stored preferences or social graph; process the menu items, allergies, and preferences to select coffee hose menu items for user 906; and generate assets (e.g., content data) for the selected menu item. In addition, location data 1206 defines that virtual object 1102 should be displayed over the recognized menu.

In some implementations, updated contextual factors for XR device 904 and user 906 (e.g., after user 906 enters the coffee house) are compared to invocation context 1202 on XR device 904. For example, components of the application can be transmitted to XR device 904, and the comparison that determines when and which virtual objects of the application to display can be performed at XR device 904 (e.g., by a received virtual object manager). In other implementations, updated contextual factors for XR device 904 and user 906 (e.g., after user 906 enters the coffee house) can be transmitted to the cloud environment, and the updated contextual factors are compared to invocation context 1202 at the cloud environment. In this example, once virtual object 1102 is invoked, the virtual object can be transmitted to XR device 904 (along with other components of the application).

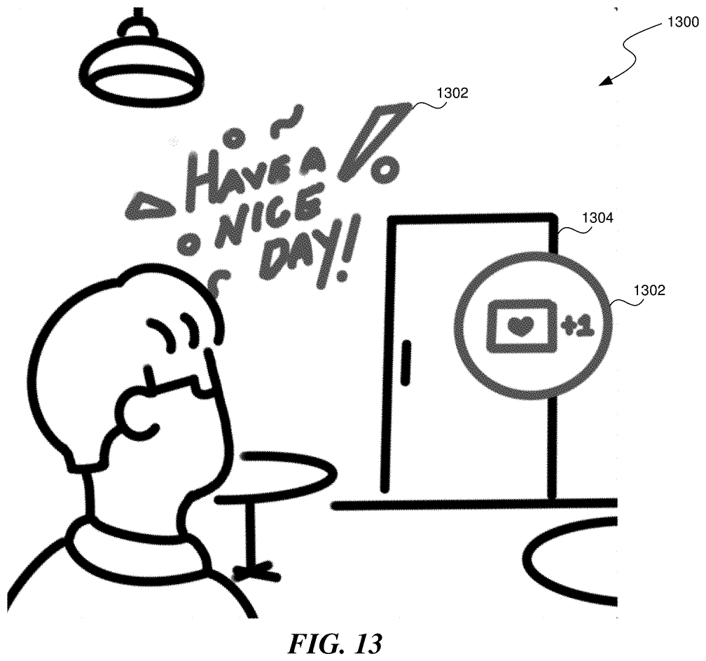

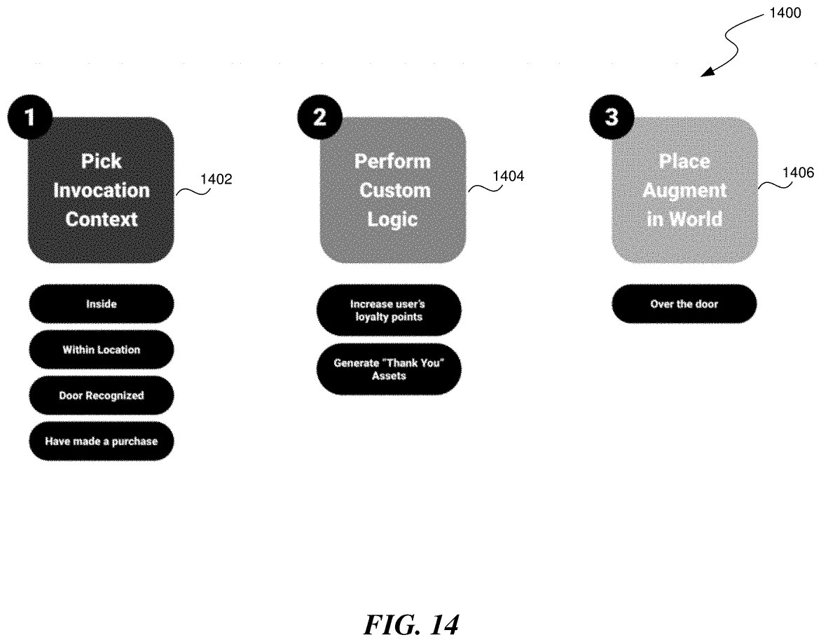

Diagram 1300 of FIG. 13 illustrates an artificial reality environment inside the coffee house (after display of virtual objects 902 and 1102 and after user 906 enters the coffee house and purchases a menu item). Virtual object 1302 can be displayed adjacent to the coffee house's real-world door 1304. Conceptual definition 1400 of FIG. 14 illustrates the definition of virtual object 1302. For example, invocation context 1402 for virtual object 1302 can include the following data attributes and values: Inside_Outside==“inside” AND Current_location within Predefined_location AND Door_Recognized==True AND TransactionState==“completed purchase”. Because invocation context 1402 is met, application logic 1404 can be executed. Application logic 1404 can, when executed, increase user 906's loyalty points with the coffee house (e.g., through an application programming interface (“API”) call to a third-party system) and generate thank you assets (e.g., content data). In addition, location data 1406 for virtual object 1302 defines that the virtual object should be displayed over the recognized door. Updated contextual factors for XR device 904 and user 906 (e.g., after user 906 enters the coffee house and purchases an item) are compared to invocation context 1202 on XR device 904 (e.g., by a received virtual object manager) or in a cloud environment.

In some implementations, each virtual object that serves as a component of an application can be defined. In other implementations, defined virtual objects can be standalone objects (e.g., not part of an application). A user, admin, or any suitable entity can define the virtual objects using any suitable interface for inputting definition information, media, or other data for defining the virtual object.

Those skilled in the art will appreciate that the components illustrated in FIGS. 1-14 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 15 is a flow diagram for defining a virtual object. In some implementations, process 1500 can be used to define a virtual object that can later be displayed at an XR device. Process 1500 can be triggered by a user or admin that is configuring a virtual object or an application (e.g., set of virtual objects).

At block 1502, process 1500 can receive an invocation context for a virtual object. For example, a user and XR device can include contextual factors, such as a location, time of day, type of device, setting (e.g., indoor or outdoor), and the like. The invocation context of a virtual object can include data attributes and data attributes values that correspond to these contextual factors. In some implementations, the invocation context is a statement or expression, such as a series of conditions combined by logical operators. The contextual factors can be received from a user or admin using an interface (e.g., a web forms, an application, or other suitable interface) configured to permit the user or admin to select data attributes and data attribute values for a given condition and combine multiple conditions using logical operators.

At block 1504, process 1500 can receive application logic and content for the virtual object. The application logic can be code that, when executed, generates content data for the virtual object and powers interactions with and/or functionality for the virtual object. The received application logic can include queries for retrieving data, code to call APIs, code that includes virtual object's controller, code to process and analyze retrieved data and generate content for the virtual object, etc.

For example, at block 1506 process 1500 can receive a controller for the virtual object. For example, the controller can include application logic for the virtual object to respond to input (e.g., user actions, world state/context, and outputs from system services/applications, etc.). The controller can define virtual object rules for object behaviors, spatial behaviors, component management, data management, social actions, notification actions, privacy actions, system actions, etc. In some cases, the controller can define which services the virtual object hooks up to and how the virtual object responds to events from those services.

The controller can also include definitions for how virtual objects plug into each other (e.g., a controller of a first person virtual object can define a connection to a second person virtual object based on a social graph indicating the user associated with the first person virtual object and the user associated with the second person virtual object are defined as “friends.”). The controller can specify both internal logic for the virtual object and how the virtual object will operate in different environments and through the controller, the virtual object can be hooked into multiple network enabled services—e.g., social media platforms, news sources, weather sources, internet of things/smart home data, connections to local devices, messaging/calling services, mapping services, shopping services, transportation services, financial services, gaming systems, media providers, calendar services, storage providers, security services, etc. In some implementations, the rules specified by the controller may depend on a view state of the virtual object. The rules specified by the controller may also depend on any number of other factors such as which other people or objects are in the vicinity, how the virtual object is grouped with or linked to other objects, a state associated with the current user, etc.

At block 1508, process 1500 can receive a template for the virtual object. For example, a template can include multiple view states, where each view state defines how the virtual object presents itself when that view state is active. A view state can, e.g., set a configuration of the container, map which data elements of the virtual object are displayed and where they are displayed within the container, which UI elements are shown/hidden, or define other output for the virtual object. The template can act as a state machine where each view state is a state in the state machine and there is contextual breakpoint logic that defines when the virtual object transitions between the view states.

At block 1510, process 1500 can receive data for the virtual object. For example, the received data can be data elements imported from external sources such as a social media platform. These data elements can live external to the virtual object, can be periodically updated, or can have updates pushed to them as the external data elements change. Example data element include a user's online status as maintained in a first social media platform, a broadcast message maintained in a second social media platform (e.g., that a user has selected to display when her avatar appears in another's artificial reality environment), and other suitable data elements. These data elements can be updated as the user's status or broadcast message changes on the various social media platforms.

In some implementations, the virtual object can also have internal data elements. For example, a person virtual object may have a name which exists locally to the virtual object and is only set when the person virtual object is first created and may have an avatar, which is copied to the virtual object and exists locally, only being updated when the user updates the avatar through the virtual object. The data for a virtual object may have fields that link to an external source, but are not set in that source and thus remain empty. For example, the user corresponding to a person virtual object may not have set a profile picture on a social media platform, and thus the profile picture data element may be empty. In some cases, the virtual object can define interactions or relationships among its data elements. For example, a person virtual object could define set of user IDs that each specify the corresponding user profile on a corresponding social media platform.

At block 1512, process 1500 can receive a container for the virtual object. For example, a virtual object's container can define the volume the virtual object is authorized to write into. In some cases, the container can be a set of nested containers, e.g., an outer container for the entire virtual object which can include A) a data container to hold the display elements of the virtual object (selected and organized according to a current view state as discussed below) and B) zero or more chrome containers to hold UI elements associated with the virtual object. The received container can be a manifest defining details of the container for the virtual object. In operation, a virtual object's container can be provided by a controlling application (e.g., operating system, shell, or other application in control of the artificial reality environment) to an application requesting to create a virtual object. For example, the application can submit a manifest to the controlling application defining details of the container needed and can receive back a handle to the container having been assigned permissions to write, by way of the handle, into the volume that the container occupies. Any suitable definition can be received to define the container for the virtual object.

In some implementations, application logic received at block 504 includes code (e.g., query or data retrieval code) that retrieves data from data sources. For example, a query can include structured query language statements or other suitable query language data. In some implementations, the queries or retrieval code can be configured to target a user or the user's social graph so that when the application logic is executed the content generated for a virtual object is tailored to each user.

In another example, received application logic can include code to call one or more third-party APIs. For example, some content data for a virtual object may be stored by a third-party, and that content can be retrieved by code that calls an API to access the third-party's data store. In another example, an interaction with a virtual object may update data stored by a third-party, and the update can be made by code that calls an API to perform the update.

In another example, received application logic can include code that analyzes data and generates content data for the virtual object. For example, the application logic as a whole may retrieve several pieces of data, and code can be received that analyzes the retrieved pieces of data to perform a function. For example, a virtual object for a restaurant may retrieve data such as menu items, the user's transaction history, the user's preferences, preferences from the user's social graph, the user's allergies, and the like. The application logic can include code that analyzes the menu items based on other retrieved data, such as user preferences, allergies, and/or trends in the user's transaction history, to select an item for the user. Code can then generate content data related to the selected menu item for the virtual object to display.

At block 1514, process 1500 can receive virtual object location data. For example, an attach point for a virtual object can be received. When the defined virtual object is displayed in an artificial reality, the initial display location can be controlled by the defined virtual object location data. The location data can specify coordinates relative to an origin point, relative to the user, in a user's field of view, or relative to a specified object. For example, the location data for a virtual object defined for a business can specify that the virtual object should be initially placed six inches above and to the right of an identified entry way for the business. As another example, the location data for a virtual object that is part of a messaging application displaying a message from a user can specify the virtual object should be placed just above the head of an avatar representing the user who sent the message.

In some implementations, the virtual object definition can include application data. For example, the virtual object may be part of an application, or a set of virtual objects can be defined by a developer as a part of the same application. In some implementations, a developer creates an application by creating a collection of virtual objects that are linked. For example, process 500 of FIG. 5 can be repeated multiple times to generate a set of virtual objects that are linked (e.g., using a common application ID). In some implementations, a virtual object manager can then be associated with the application/set of virtual objects. For example, the application manager can be common software shared by applications or can be specifically defined by the developer (e.g., the creator of the application/set of virtual objects). The application manager can perform the following example functions: A) determine which invocation contexts are met/are likely to be met, retrieve the corresponding virtual objects, and store these virtual objects local to the XR device, and B) determine which virtual object with met invocation contexts should be displayed given other virtual objects that are displayed and/or given the current set of contextual factors.

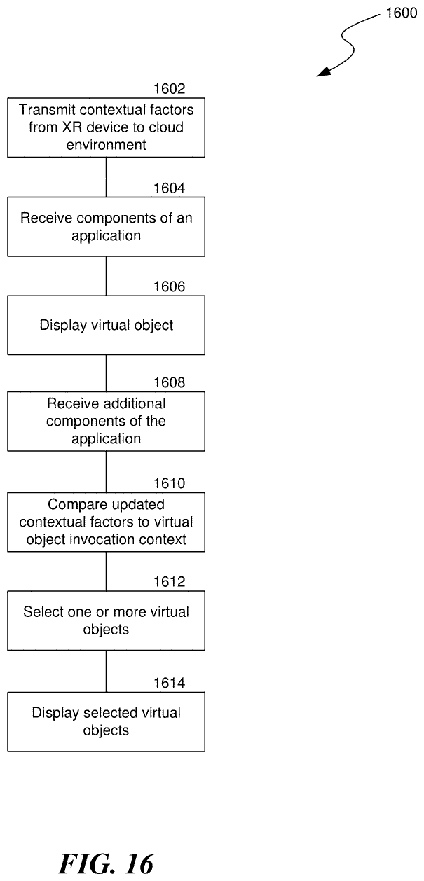

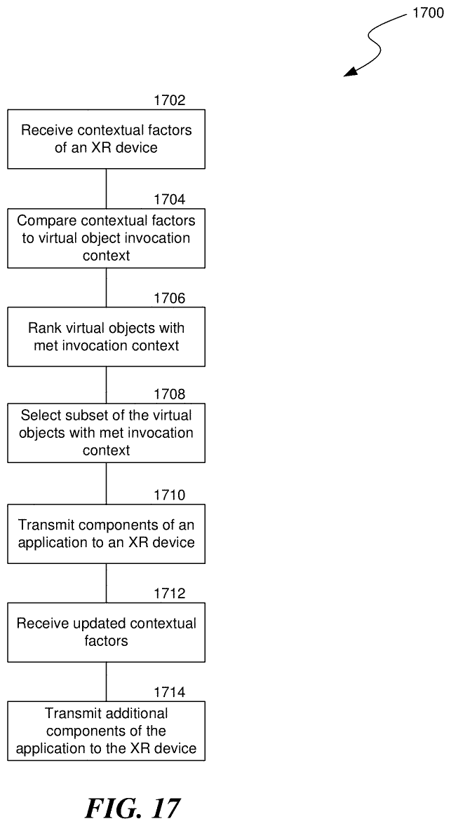

Once virtual objects are defined, an XR device associated with (e.g., worn by) a user can cause one or more of the virtual objects to be displayed based on the XR device and user's contextual factors. FIGS. 16 and 17 are flow diagrams for invoking and displaying virtual objects in an artificial reality system. In some implementations, process 1600 can be performed by an XR device configured to display virtual objects and process 1700 can be performed by a cloud computing environment. Processes 1600 and 1700 can be triggered when an XR device displays an artificial reality to a user and/or when contextual factors for the user and XR device trigger the processes. Some or all of the functionality of processes 1600 and 1700 can be performed by the XR device, the cloud computing environment, or by any other suitable computing device.

At block 1602, process 1600 can transmit contextual factors for the XR device and user to a cloud computing environment. For example, the contextual factors can include environmental context, user context, and device context. The user context can include one or more of: the user's social media graph, the user's preference settings, the user's transaction or purchase history, the user's posture or pose, the user's gaze direction, any combination thereof, or other suitable user context.

The environmental context can include one or more of: a density of surrounding people, whether the XR device is in an indoor or outdoor setting, weather conditions, time of day, day of week, time of year, who the user is interacting with, which identified objects are around the XR device, features of the room the XR device is in, any combination thereof, or other suitable environmental context. The device context can include one or more of: the XR device's location, power state, current input mode, network connection, orientation, motion characteristics, any combination thereof, or other suitable environmental context. In some implementations, certain portions of the contextual factors can be retrieved (by the XR device or cloud computing environment) from a data store other than the XR device, such as a device that stores the user's social graph and other user related data on a social media platform, weather data, date/time data, etc. In some implementations, the user's social graph can refer to data retrieved or accessed from a social graph in relation to the user.

In some implementations, the cloud computing environment compares the contextual factors to invocation context of a plurality of virtual objects. For example, invocation context of at least one virtual object can be met by the contextual factors, and the at least one virtual object can be part of an application (e.g., a set of virtual objects defined by a developer to be part of the same application). Process 1700 of FIG. 17 further descries the functionality of the cloud computing environment.

At block 1604, process 1600 can receive one or more components of the application including at least a virtual object. For example, the virtual object's invocation context can be met by the XR device and user's contextual factors, and in response the cloud computing environment can transmit components of the application, including the virtual object, to the XR device.

In some implementations, the components of the application received at the XR device can include one or more additional virtual objects and/or a virtual object manager. For example, the virtual object manager can be code configured to manage the application's execution (e.g., the display of the application's virtual objects) on the XR device. In some implementations, the virtual object manager can perform the following functions: matching (or partially matching) invocation contexts corresponding to virtual objects of an application and retrieving (e.g., preloading or caching on-device) these virtual objects; and selecting which among the application's virtual objects with met invocation context should be displayed in the artificial reality environment.

At 1606, process 1600 can display the at least one virtual object (e.g., received virtual object with met invocation criteria) in an artificial reality environment. For example, the XR device can display the virtual object to the user at a display location defined in the virtual object's definition. Displaying the virtual object can cause the virtual object to execute its application logic to select content and configure itself for how and where the virtual object is displayed.

At 1608, process 1600 can receive additional components of the application. For example, additional virtual objects of the application and/or a virtual object manager can be received at the XR device. These additional components can be received after display of the initial virtual object of the application (e.g., after 1606). For example, if the user selects or otherwise interacts with the virtual object displayed at block 1606, the application that virtual object is a part of can be installed on the XR device (e.g., by retrieving the application's virtual object manager and/or one or more other of the virtual objects that make up the application). In some implementations, the additional components are received in response to updated contextual factors, user interaction with the displayed virtual object, or any other suitable change or cause.

For example, the one or more components of the application received at block 604 can be less than all the virtual objects in the set of virtual objects that are comprised by the application. The virtual object manager can obtain additional ones of the set of virtual objects, for local caching, in response to a part of the invocation context of the additional ones of the set of virtual objects being met. In some implementations, the virtual objects dynamically retrieved (e.g., locally cached) by the virtual object manner can have invocation context that are partially matched by current contextual factors. For example, where a given invocation context includes an expression with four conditions, a threshold number of conditions (e.g., two, three, etc.) can be met, and the virtual object manager can dynamically retrieve the corresponding virtual object based on the partial match.

At 1610, process 1600 can compare updated contextual factors to invocation context of additional virtual objects. For example, the user and XR device can interact with the real-world, move into new spaces, or other changes can cause an update to the user and XR device's contextual factors. The updated contextual factors can be compared to invocation context for multiple virtual objects (e.g., additional virtual objects of the application). In some implementations, a virtual object manager has been received at the XR device, and the virtual object manager can perform the comparison and determine when additional virtual objects of the application should be invoked and displayed.

In some implementations, a set of multiple virtual objects can have a met invocation context. At 1612, process 1600 can select for display one or more virtual objects from among the set of virtual objects with met invocation contexts. For example, the set of virtual objects can be ranked. In some implementations, the ranking can represent a relevance between contextual factors of each virtual object's invocation context and the user and/or between tags specified for the virtual object and the user. For example, the virtual objects that are higher in the ranking can represent virtual objects in the set that are more relevant to the user. The relevance determinations can be based on one or more of user preferences, user transaction history, location, time of day, and any other suitable contextual factors.

In some implementations, the ranking can be based on the specificity of the virtual object's invocation context. For example, specific invocation context may be met with less frequency than broad invocation context. Accordingly, virtual objects with a specific invocation context may already incorporate a degree of relevance selectivity. In some implementations, specificity may be based on a number of conditions an invocation context combines (e.g., a number of conditions combined by logical operators), an observed frequency with which the invocation contexts are met, or other suitable specificity metrics. An example ranking based on specificity may rank virtual objects with high specificity higher in the ranking. Any other suitable ranking can be implemented.

In examples that include a ranking, one or more virtual objects ranked highest in the ranking can be selected for display. At 1614, process 1600 can display the one or more selected virtual objects. For example, the selected virtual objects can be displayed to the user at the XR device at locations specified in the selected virtual objects' definitions.

Process 1700 can represent the functionality of a cloud computing environment in communication with the XR device. Some or all of the functionality of the XR device described with reference to process 1600 and the cloud computing environment described with reference to process 1700 can be performed by either computing device, or portions of the functionality can be performed by any other suitable computing device.

At block 1702, process 1700 can receive contextual factors for an XR device and user at a cloud computing environment. For example, the contextual factors can include environmental context, user context, and device context. The user context can include one or more of: the user's social media graph, the user's preference settings, the user's transaction or purchase history, the user's posture or pose, the user's gaze direction, any combination thereof, or other suitable user context. The environmental context can include one or more of: a density of surrounding people, whether the XR device is in an indoor or outdoor setting, weather conditions, time of day, day of week, time of year, who the user is interacting with, which identified objects are around the XR device, features of the room the XR device is in, any combination thereof or other suitable environmental context. The device context can include one or more of: the XR device's location, power state, current input mode, network connection, orientation, motion characteristics, any combination thereof, or other suitable environmental context. In some implementations, certain portions of the contextual factors can be stored at a data store, such as a device that stores the user's social graph and other user related data, and this data can be accessed, retrieved, and/or transmitted to the cloud computing environment.

At block 1704, process 1700 can compare the contextual factors to invocation context of a plurality of virtual objects. For example, invocation context of at least one virtual object can be met by the contextual factors, and the at least one virtual object can be part of an application (e.g., a set of virtual objects defined by a developer to be part of the same application). The invocation context of the virtual object can include an expression that combines several conditions (e.g., using logical operators). The expression can contain data arguments (e.g., elements of data, such as time of day, day of week, location, and the like) and the argument values (e.g., data values) that the arguments should hold to invoke the virtual object. Data values from the current contextual factors of an XR device and user can be evaluated using the expression defined in the invocation context of a virtual object. When the expression evaluates to “True” or “1”, the virtual object's invocation context is met and when the expression evaluates to ‘False” or “0”, the virtual object's invocation context is not met.

In some implementations, a set of multiple virtual objects can have a met invocation context. At 1706, process 1700 can rank the virtual objects in the set with the met invocation contexts. For example, the ranking can represent a relevance between contextual factors of each virtual object's invocation context and the user and/or between tags specified for the virtual object and the user. For example, the virtual objects that are higher in the ranking can represent virtual objects in the set that are more relevant to the user. The relevance determinations can be based on one or more of user preferences, user transaction history, location, time of day, and any other suitable contextual factors.

In some implementations, the ranking can be based on the specificity of the virtual object's invocation context. For example, specific invocation context may be met with less frequency than broad invocation context. Accordingly, virtual objects with a specific invocation context may already incorporate a degree of relevance selectivity. In some implementations, specificity may be based on a number of conditions an invocation context combines (e.g., a number of conditions combined by logical operators), an observed frequency with which the invocation contexts are met, or other suitable specificity metrics. An example ranking based on specificity may rank virtual objects with high specificity higher in the ranking. Any other suitable ranking can be implemented.

At 1708, process 1700 can select one or more virtual objects from among the set of virtual objects with met invocation contexts. For example, one or more virtual objects ranked highest in the ranking can be selected. In some implementations, at least one selected virtual object can be part of an application (e.g., a set of virtual objects defined by a developer to be part of the same application). In this example, multiple of the selected virtual objects can be part of the same application or different applications.

At block 1710, process 1700 can transmit one or more components of an application to the XR device. In some implementations, the components of the application received at the XR device can include one or more additional virtual objects of the application and/or a virtual object manager. For example, the virtual object manager can be code configured to manage the application's execution (e.g., the display of the application's virtual objects) on the XR device. In some implementations, the virtual object manager resident on the XR device can perform the following functions: matching (or partially matching) invocation contexts corresponding to virtual objects of an application and retrieving (e.g., preloading or caching on-device) these virtual objects from the cloud computing environment; and selecting which among the application's virtual objects with met invocation context should be displayed in the artificial reality environment. In some implementations where the selected virtual objects are part of multiple applications, components from multiple applications can be transmitted to the XR device.

In some implementations, at least one virtual object received by the XR device can be displayed in an artificial reality environment. For example, the XR device can display the virtual object to the user at a display location defined in the virtual object's definition.

At block 1712, process 1710 can receive updated contextual factors from the XR device. For example, the user and XR device can interact with the real-world or artificial reality, move into new spaces, or other changes can cause an update to the user and XR device's contextual factors. In some implementations, the updated contextual factors can be retrieved, accessed, or received from other computing devices that store contextual factors for the XR device and/or user.

At block 1714, process 1710 can transmit additional components of the application to the XR device. For example, additional virtual objects of the application and/or a virtual object manager can be transmitted to the XR device. These additional components can be transmitted after display of the initial virtual object of the application at the XR device. In some implementations, the additional components are received in response to updated contextual factors, user interaction with the displayed virtual object, requests from a virtual object manager at the XR device, or any other suitable change or cause.

In some implementations, the XR device (e.g., the virtual object manager on the XR device) compares updated contextual factors to invocation context for additional application virtual objects, and determines which virtual objects for the application should be displayed under various circumstances. In this example, the XR device may transmit requests for components of the application, and the cloud computing environment may respond to these requests with the components.

In some implementations, the XR device continues to update the cloud computing environment with updated contextual factors and the cloud computing environment continues to compare the contextual factors to invocation context of a variety of virtual objects. For example, while components of one or more applications may be stored at the XR device, the cloud computing environment may store many more applications and/or virtual objects. Accordingly, invocation context for new virtual objects and/or applications can be met by the updated contextual factors, and components for additional applications can be transmitted to the XR device under changing contextual factors at various times.

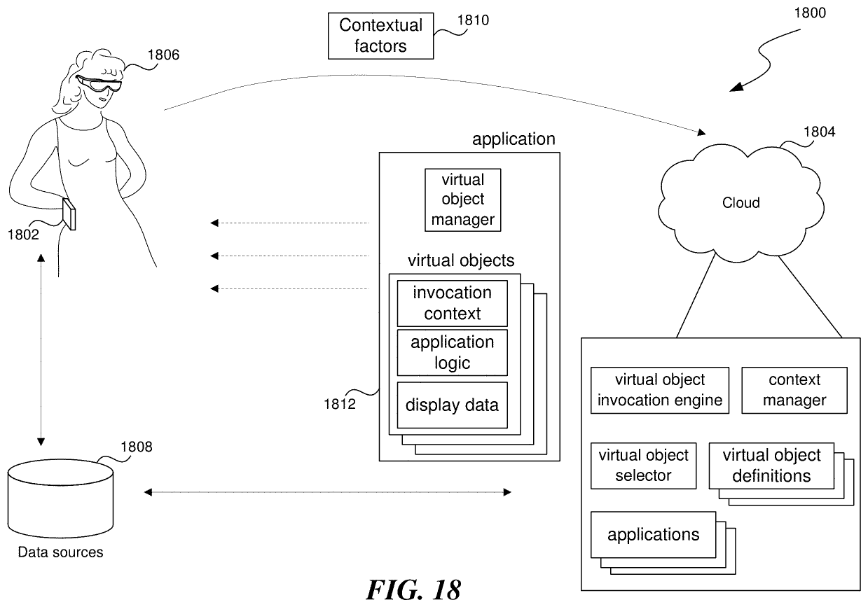

FIG. 18 is a diagram of a system for invoking and displaying virtual objects in an artificial reality system. System 1800 includes XR device 1802, cloud computing environment 1804, user 1806, data store 1808, contextual factors 1810, and application 1812. In operation, an artificial reality environment can be implemented by XR device 1802 worn by user 1806. User 1806 can then experience the real-world through the interface of XR device 1802. XR device 1802 and user 1806 can be associated with contextual factors 1810, such as the device location, time of day, day of week, user preferences, use's transaction or purchase history, weather conditions, density of surrounding people, indoor or outdoor setting, and many others. In some implementations, contextual factors 1810 can include user context, device context, and environmental context.

Cloud computing environment 1804 can store virtual object definitions and one or more applications, which can include a set of virtual objects defined by a developer to be part of the same application. The virtual objects can be defined by at least an invocation context, application logic and content, and display location. The invocation context of a virtual object can be defined as one or more contextual data attributes and the data values of these attributes. For example, a virtual object may include the following invocation context: indoor, proximate to a predefined location (e.g., restaurant location), during non-night hours, on a weekend.

In some implementations, the context manager of cloud computing environment 1804 can compare contextual factors 1810 to the invocation contexts for multiple virtual objects to determine whether any of the invocation contexts are met. When contextual factors 1810 (e.g., contextual attributes and data values) meet the conditions that define a virtual object's invocation context, the virtual object can be invoked. In operation, XR device 1802 transmits contextual factors 1810 to cloud computing environment 1804 (in some cases, the cloud computing environment 1804 can also obtain additional contextual factors, such as by accessing a third-party data store, e.g., by supplying an ID of the user to a social media platform, by supplying a time and location to a weather platform, by supplying access credentials to a media storage platform, etc.), and contextual factors 1810 can be compared to invocation context of multiple virtual objects. For example, cloud computing environment 1804 can store multiple (e.g., a large number, such as thousands, millions, or even billions) of virtual object definitions, and contextual factors 1810 may be relevant to a subset of these multiple virtual objects. The context manager can compare contextual factors 1810 to invocation context of the subset of virtual objects to determine whether any of the virtual objects' invocation context are met.

In some implementations, application 1812 includes a set of virtual objects. For example, a particular entity location (e.g., restaurant location) can include several virtual objects for display at various locations in or proximate to the entity location. When the invocation context of a virtual object that is part of application 1812 is met, components of application 1812 can be transmitted from cloud computing environment 1804 to XR device 1802.

For example, receiving application 1812 at XR device 1804 can include receiving the following data items for a virtual object of the application: invocation context, application logic, and display location data. Invoking a virtual object can include running the virtual object's defined application logic to retrieve data relevant to the virtual object, analyzing or processing the data, and generating content for the virtual object's display. For example, the application logic can include code to: retrieve menu items from a data source associated with a restaurant location, retrieve user preference from a user's social graph, retrieve medical information for a data source related to the user, and the like. This data can then be analyzed to arrive at content data for the virtual object. In the above example, code can be defined that analyzes user preferences and allergies to select or highlight one or more menu items from a restaurant's food menu. In some implementations, running application logic of a virtual object includes accessing data sources 1808 or making third-party API calls. Any other suitable application logic can be implemented.

The virtual object definition can also include location data that defines how the virtual object is to be displayed in the artificial reality environment. For example, the location data can define that the virtual object should be displayed proximate to a menu in a particular restaurant. In this example, because the invocation context of the virtual object is related to a restaurant location, the restaurant's menu is expected to be near or proximate user 1806 and XR device 1802. XR device 1802 can be configured to display the virtual object according to the virtual object's data (e.g., display the virtual reality object content at the defined location).

In some implementations, the invocation contexts for multiple virtual objects can be met by contextual factors 1810. In this example, a virtual object selector at cloud computing environment 1804 can rank the multiple virtual objects with met invocation contexts and select a subset for transmission to XR device 1802. For example, the ranking can represent a relevance to contextual factors 1810 and/or user 1806. The ranking can be based on one or more of user preferences, user transaction history, location, time of day, and any other suitable contextual factors 1810. In some implementations, the ranking can be based on the specificity of the virtual object's invocation context. For example, specificity may be based on a number of conditions an invocation context combines (e.g., a number of conditions combined by logical operators), an observed frequency with which the invocation contexts are met, or other suitable specificity metrics. An example ranking based on specificity may rank virtual objects with high specificity higher in the ranking. Any other suitable ranking can be implemented. In examples that include a ranking, one or more virtual objects ranked highest in the ranking can be selected by the virtual object selector.

In some implementations, components of application 1812 can be transmitted from cloud computing environment 1804 to XR device 1802 over multiple transmissions at different times. For example, when the invocation context of an initial virtual object of application 1812 is met (or the initial virtual object is selected by the virtual object selector), some components of application 1812 can be transmitted to XR device 1802 (e.g., the initial virtual object and one or more additional virtual objects). After the initial transmission to XR device 1802, additional components of application 1812 can be transmitted to XR device 102 later in time. For example, updated contextual factors 1810 and/or user interactions can trigger the transmission of the additional components. As a more specific example, cloud computing environment 1804 can determining that five virtual objects, all from different applications, have met invocation to contexts and can supply just these initial five virtual objects to XR device 1802. When a user interacts with one of the five virtual objects, XR device 1802 can “install” that application on the XR device 1802, meaning XR device 1802 obtains the virtual object manager for that application and some or all of the remaining virtual objects of that application. If not all the virtual objects of that application are supplied to the XR device 1802, as the virtual object manager determines that the invocation contexts for additional virtual objects are met, partially met, or are likely to be met given current circumstances, the virtual object manager can locally cache the corresponding virtual objects of the application. Thus, when the invocation contexts for these additional virtual objects are met, they are locally available for immediate display.

In some implementations, the virtual object manager can be transmitted to XR device 1802 as a component of application 1812. For example, the virtual object manager can be provided to XR device 1802 when the initial virtual object is transmitted or at a later point in time when additional components of application 1812 are transmitted. The virtual object manager for application 1812 can be code configured to manage application 1812's execution (e.g., the display of the application's virtual objects) on XR device 1802. For example, the virtual object manager can perform comparisons between contextual factors 1810 (and updates to the factors) and invocation context for virtual objects of application 1812 to determine when additional virtual objects of application 1812 should be invoked and displayed.

In some implementations, the virtual object manager can request one or more components of application 1812 from cloud computing environment 1804. In some implementations, when invocation context for multiple virtual objects of application 1812 are met, the virtual object manager can select a subset of the multiple virtual objects for display. For example, the virtual object manager can select the subset of virtual objects in a manner similar to the virtual object selector of the cloud computing environment 1804.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for displaying invoked virtual objects, the method comprising:
transmitting contextual factors for an artificial reality (XR) device and a user to a cloud computing environment, wherein:
the cloud computing environment compares the contextual factors to invocation contexts of a plurality of virtual objects,
the invocation context of at least one virtual object is met by the contextual factors, and
the at least one virtual object is part of an application that comprises a set of virtual objects;
receiving one or more components of the application including the at least one virtual object;
displaying the at least one virtual object in an artificial reality environment of the XR device; and
receiving one or more additional components of the application in response to updated contextual factors.

2. The method of claim 1, further comprising:
receiving a virtual object manager that retrieves the additional components of the application and manages display of the set of virtual objects in the artificial reality environment of the XR device.

3. The method of claim 1, wherein the additional components of the application comprise the set of virtual objects.

4. The method of claim 2, further comprising:
updating the contextual factors based on real-world updates;
after displaying the at least one virtual object, comparing, by the virtual object manager on the XR device, the updated contextual factors to the invocation contexts for each virtual object in the set of virtual objects, wherein one or more of the set of virtual objects are invoked when the invocation context of the one or more virtual objects is met by the updated contextual factors; and
displaying the one or more virtual objects in the artificial reality environment.

5. The method of claim 4, wherein the one or more additional components of the application comprising the set of virtual objects are received prior to invocation of the one or more virtual objects.

6. The method of claim 4,
wherein the one or more virtual objects include less than all the virtual objects in the set of virtual objects that are comprised by the application; and
wherein the virtual object manager obtains additional ones of the set of virtual objects, for local caching, in response to a part of the invocation context of the additional ones of the set of virtual objects being met.

7. The method of claim 4, further comprising:
ranking multiple of the one or more virtual objects; and
selecting, based on the ranking, a subset from the multiple of the one or more virtual objects for display.

8. The method of claim 1, wherein the contextual factors comprise two or more of environmental context, user context, and device context.

9. The method of claim 8, wherein
the user context comprises one or more of: the user's social media graph, the user's preference settings, the user's transaction or purchase history, the user's posture or pose, the user's gaze direction, or any combination thereof,
the environmental context comprises one or more of: a density of surrounding people, whether the XR device is in an indoor or outdoor setting, weather conditions, time of day, day of week, time of year, who the user is interacting with, which identified objects are around the XR device, features of the room the XR device is in, or any combination thereof, and
the device context comprises one or more of: the XR device's location, power state, current input mode, network connection, orientation, motion characteristics, or any combination thereof.

10. The method of claim 1, wherein the invocation context for the at least one virtual object comprises an expression that combines multiple contextual factors for invoking the at least one virtual object.

11. The method of claim 1, wherein the at least one virtual object comprises application logic, and the at least one virtual object is displayed by running the application logic to generate display content.

12. A computer-readable storage medium storing instructions that, when executed by a computing system, cause the computing system to perform a process for displaying invoked virtual objects, the process comprising:
transmitting contextual factors for an artificial reality (XR) device and a user to a cloud computing environment, wherein:
the cloud computing environment compares the contextual factors to invocation contexts of a plurality of virtual objects,
the invocation context of at least one virtual object is met by the contextual factors, and
the at least one virtual object is part of an application that comprises a set of virtual objects;
receiving one or more components of the application including the at least one virtual object;
displaying the at least one virtual object in an artificial reality environment of the XR device; and
receiving one or more additional components of the application in response to updated contextual factors.

13. The computer-readable storage medium of claim 12, wherein the process further comprises:
receiving a virtual object manager that retrieves the additional components of the application and manages display of the set of virtual objects in the artificial reality environment of the XR device.

14. The computer-readable storage medium of claim 12, wherein the additional components of the application comprise the set of virtual objects.

15. The computer-readable storage medium of claim 13, wherein the process further comprises:
updating the contextual factors based on real-world updates;
after displaying the at least one virtual object, comparing, by the virtual object manager on the XR device, the updated contextual factors to the invocation contexts for each virtual object in the set of virtual objects, wherein one or more of the set of virtual objects are invoked when the invocation context of the one or more virtual objects is met by the updated contextual factors; and
displaying the one or more virtual objects in the artificial reality environment.

16. The computer-readable storage medium of claim 15,
wherein the one or more virtual objects include less than all the virtual objects in the set of virtual objects that are comprised by the application; and
wherein the virtual object manager obtains additional ones of the set of virtual objects, for local caching, in response to a part of the invocation context of the additional ones of the set of virtual objects being met.

17. The computer-readable storage medium of claim 15, wherein the process further comprises:
ranking multiple of the one or more virtual objects; and
selecting, based on the ranking, a subset from the multiple of the one or more virtual objects for display.

18. A computing system for displaying invoked virtual objects, the computing system comprising:
one or more processors; and
one or more memories storing instructions that, when executed by the one or more processors, cause the computing system to perform a process comprising:
transmitting contextual factors for an artificial reality (XR) device and a user to a cloud computing environment, wherein:
the cloud computing environment compares the contextual factors to invocation contexts of a plurality of virtual objects,
the invocation context of at least one virtual object is met by the contextual factors, and
the at least one virtual object is part of an application that comprises a set of virtual objects;
receiving one or more components of the application including the at least one virtual object;
displaying the at least one virtual object in an artificial reality environment of the XR device; and
receiving one or more additional components of the application in response to updated contextual factors.

19. The computing system of claim 18, wherein
the contextual factors comprise two or more of environmental context, user context, and device context,
the user context comprises one or more of: the user's social media graph, the user's preference settings, the user's transaction or purchase history, the user's posture or pose, the user's gaze direction, or any combination thereof,
the environmental context comprises one or more of: a density of surrounding people, whether the XR device is in an indoor or outdoor setting, weather conditions, time of day, day of week, time of year, who the user is interacting with, which identified objects are around the XR device, features of the room the XR device is in, or any combination thereof, and
the device context comprises one or more of: the XR device's location, power state, current input mode, network connection, orientation, motion characteristics, or any combination thereof.

20. The computing system of claim 18, wherein the invocation context for the at least one virtual object comprises an expression that combines multiple contextual factors for invoking the at least one virtual object.
